(19) United States
(12) Patent Application Publication
(10) Pub. No.: US 2004/0150715 A1
(43) Pub. Date: Aug. 5, 2004

(54) Image-capture event monitoring

(75) Inventors: Lawrence Wilcock, Malmesbury (GB); Paul St John Brittan, Claverham (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/696,096

(22) Filed: Oct. 28, 2003

(30) Foreign Application Priority Data
Jan. 31, 2003 (GB) 0302243.1

(51) Int. Cl. H04N 7/18

(52) U.S. Cl. 348/143

(57) ABSTRACT

In order to monitor image-capture events, notifications of such events are sent to a service system. From each notification a location parameter is derived that is indicative of the location of occurrence of the corresponding event. At the service system the notified events are associated into clusters and events in a cluster are then analysed in dependence on at least one further parameter of each event. This further parameter is, for example, the time of occurrence of the corresponding event; in this case, it is possible to determine the existence of a currently-happening attraction or when a regularly-occurring attraction is next to happen. In another embodiment, the further parameter is the direction of image capture for the event and in this case it is possible to determine the likely subject of image-capture events of a cluster.

### FIELD OF THE INVENTION

The present invention relates to image-capture event monitoring.

As used herein, the term “image capture” is intended to cover any form of image capture by camera functionality whether involving still photographs or video or film clips and including both visible-light image capture and infra-red image capture.

### BACKGROUND OF THE INVENTION

It is a common human experience to arrive at a seemingly interesting attraction, such as film or television star making a public appearance or a Mickey Mouse character giving out toys to children in a theme park, just as the attraction has finished and the crowds are dispersing. Many interesting attractions and places to visit are missed by most people simply because they are unaware of that these attractions and places exist; furthermore, often such attractions and places are not to be found in the standard guides.

It is an object of the present invention to facilitate the detection of interesting events and places.

The present invention has as one of its foundations the simple observation that image-capture activity by people is a good indicator of the presence of an attraction or place of interest, at least to a certain class of people. By monitoring and analysing the image-capture activity of people, it is possible to derive useful information about attractions and places.

It is known from our published European specification EP 1 128 284 A to transmit the location of an image capture event, without the corresponding image itself, to an internet service system for temporary storage. This specification also discloses a location-based electronic photo album in which images thumbnails can be displayed on a map in a manner indicating where the corresponding images were captured. Where there are too many images associated with a particular locality to show at a current map resolution, the images thumbnails are replaced by an icon indicating that a cluster of images is associated with the locality concerned.

### SUMMARY OF THE INVENTION

According to one aspect of the present invention, there is provided an image-capture event monitoring method comprising the steps of:

(a) receiving, from multiple different sources, image-capture event notifications and deriving from each notification a location parameter indicative of where an image-capture event has occurred;

(b) using said location parameters to associate image-capture events into one or more clusters; and

(c) analysing a said cluster of image-capture events in dependence on at least one further parameter of each event.

In one preferred embodiment, the said at least one further parameter is the time of occurrence of each image-capture event; in this case, the analysis effected in step (c) can advantageously be used to detect rapid increases in image-capture activity indicative of a currently-happening attraction, or to detect periodicity in the image-capture events indicative of the regular times of occurrence of an attraction.

In another preferred embodiment, the said at least one further parameter is the direction of image capture associated with each event; in this case, the analysis effected in step (c) can advantageously be used to determine a subject of the image-capture activity or a characteristic of the locality where the images are being captured.

According to another aspect of the present invention, there is provided a service system for monitoring image-capture event, the system comprising:

an input interface for receiving, from multiple different sources, image-capture event notifications and for deriving from each notification a location parameter indicative of where an image-capture event has occurred;

a data store for storing data derived from said event notifications;

a first processing arrangement for using said location parameters to associate image-capture events into one or more clusters; and

a second processing arrangement for analysing a said cluster of image-capture events in dependence on at least one further parameter of each event.

### BRIEF DESCRIPTION OF THE DRAWINGS

Embodiments of the invention will now be described, by way of non-limiting example, with reference to the accompanying diagrammatic drawings, in which:

FIG. 1 is a diagram of a service system embodying the invention;

FIG. 2 is a diagram illustrating the clustering of image-capture events by location;

FIG. 3 is a diagram showing the FIG. 2 event clusters overlaid on a map;

FIG. 4 is a diagram illustrating how the direction of image capture of events of a cluster enable the likely subject of the image-capture events to be determined;

FIG. 5 is a diagram similar to that of FIG. 3 but for a different cluster of events;

FIG. 6 is a diagram illustrating how the direction of image capture of events of a cluster enable a characteristic of the locality to be determined;

FIG. 7 is a diagram illustrating the detection of a currently-occurring attraction by monitoring the rate of accretion of events to a cluster;

FIG. 8 is a diagram illustrating a periodicity in the occurrence of image-capture events of a cluster; and

FIG. 9 is a diagram illustrating the expected progress of a current occurrence of a regular attraction where the current occurrence has been detected by the rate of accretion of image-capture events related to the attraction exceeding a threshold.

### BEST MODE FOR CARRYING OUT THE INVENTION

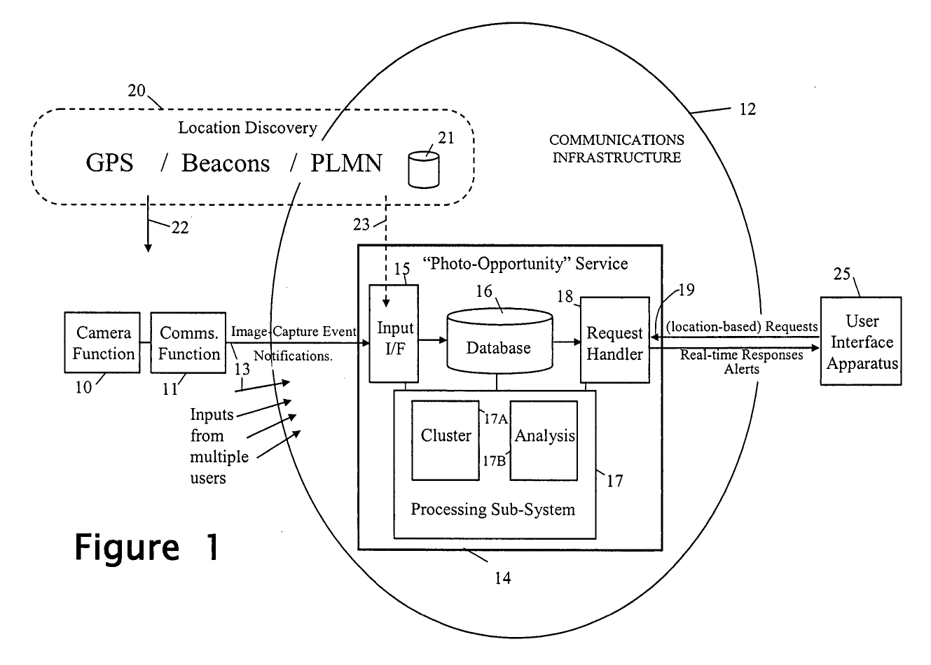

FIG. 1 depicts a “photo-opportunity” service system 14 connected to a communications infrastructure 12 in order to receive image-capture event notifications 13 and to respond to user requests 19.

The image-capture event notifications 13 serve to notify the service system 14 of corresponding image capture events effected by camera functionality 10, the notifications being sent to the service system 14 by communications functionality 11. The camera functionality 10 can be provided in stand-alone apparatus or incorporated along with other functionality into multi-function apparatus. In particular, the camera functionality and communications functionality 11 may be combined into a single apparatus such as a mobile phone/camera combination.

The image-capture event notifications are preferably sent immediately after the corresponding image capture events have occurred but it is also possible to delay sending notifications to enable, for example, a batch of notifications concerning the image-capture event of a single camera to be sent all together (typically at a fixed time or when an image-recording medium of the camera is full). Thus, in one scenario involving a digital camera with a memory stick for holding the captured images, the image-capture event notifications can be arranged to be sent when the contents of the memory stick are uploaded into equipment such as a home computer—in this case, the communications functionality 11 is, for example, constituted by internet connectivity functionality of the computer, the notifications 13 being sent out by the computer over the internet to the service system 14.

The communications infrastructure 12 can be of any suitable form and will typically comprise multiple interconnected networks of various types. For example, the service system 14 can be connected to the internet with the communications functionality 11 being arranged to communicate with the internet via a wireless LAN (such as an 802.11 network), a mobile phone network, a PSTN network, a wired LAN, or any suitable combination of the latter.

The service system 14 is arranged to receive image-capture event notifications 13 from multiple users in order to gather information about attractions and places of interest from multiple different sources rather than relying on the experiences of a single person.

The service system 14 is further arranged to service requests 19 from users (typically, subscribers to the service offered by the system 14), these requests being generated by user interface apparatuses 25. Whilst the individual apparatuses 25 and their users can be completely independent of the apparatuses providing cameras functionality 10 and their users, it is envisaged that often they will involve the same items of apparatus and users. As will be more fully explained hereinafter, in the present embodiment two types of request 19 are provided for, namely a request for real-time information (that is, a request wanting an immediate response), and a request to be sent an alert upon certain trigger conditions being met.

Each image-capture event notification 13 comprises first data concerning a location parameter indicative of the location of occurrence of the corresponding image-capture event; the notification 13 may also comprise second data relating to one or more further parameters of the event, such as its time of occurrence and/or the direction of image capture and/or an ID of the camera functionality or the associated user.

The first data can directly comprise the location of the image-capture event, or data enabling this location to be retrieved from a location server. In FIG. 1, dashed box 20 indicates location discovery functionality for providing the location of the camera functionality 10 at the time an image-capture event takes place, the capturing of an image triggering a request to the functionality 20 for a location fix. By way of example, three location discovery techniques are indicated in box 20, namely:

the use of a GPS system (typically incorporated in the same apparatus as the camera functionality 10);

the use of location beacons that transmit their respective locations using short-range communication links such as infra-red or Bluetooth wireless links (in this case, the apparatus providing the camera functionality 10 is equipped with an appropriate receiver);

the use of a mobile phone network (Public Land Mobile Network, or PLMN) to locate mobile phone functionality associated with the camera functionality 10.

It will be appreciated that any other suitable location discovery technique can be employed. Where the location of the camera functionality 10 is provided using a PLMN, the location information can either be provided to the camera functionality 10 or communications functionality 11 directly (see arrow 22) to enable the location to be included as the first data in the image-capture event notification, or else the location information can be stored in a location server 21 accessible via the communications infrastructure 12. In this latter case, the first data comprises identification data for use in retrieving the location information from location server 21, the retrieval being effected (see arrow 23) by the service system 12 upon receipt of the event notification; the identification data may, for example, comprise a user identifier and password, and a timestamp or other element for associating the image-capture event concerned with the correct item of location information held by the location server.

The service system 14 comprises an input interface 15 for receiving the image-capture event notifications 13, a database 16 for storing information directly or indirectly derived from the notifications 13, a processing sub-system 17, and a request handler 18 for handling requests from user interface apparatuses 25.

The input interface 15 is operative upon receiving an image-capture event notification 13 to derive the location parameter of the corresponding event either simply by extracting it from the notification or by using identification data included in the notification to retrieve the location parameter from the location server 21. The location parameter of the event, together with any further event parameters included in the notification 13, are stored (at least temporarily) in database 16 against a unique event ID; thereafter the processing sub-system 17 is informed of the newly-notified event.

The processing sub-system 17 (which is typically a program-controlled processor) provides cluster functionality 17A for associating events by their locations to form one or more event clusters. Upon the sub-system being informed of a newly-notified event, the functionality 17A determines on the basis of the location parameter of the event whether the event qualifies as a new member of an existing cluster of events and if this is not the case, whether the event can be used along with one or more previously-notified events not associated with any cluster, to form a new cluster. Any cluster membership determined for the newly-notified event is then stored in database 16 against the event ID. As for the criteria to be applied to determine whether an event qualifies as belonging to a particular cluster, a number of clustering algorithms are well known in the art and can be adapted for use in the current case. Indeed, any suitable criteria can be applied such as the proximity of the two nearest events to the event under consideration both being below a particular threshold.

The clustering functionality may rely on information additional to event location in making its cluster determinations. For example, reference to a map may show that events that are closely located are separated by a barrier that make it likely that events on opposite sides of the barrier are not really associated and should be treated as belonging to different clusters. A similar determination may also be made in the case where the direction of image capture of events is known and there appear to be two distinct image-capture directions associated with closely located events.

The processing sub-system 17 also includes analysis functionality 17B for analysing each cluster of events against one or more further event-specific parameters such as the time of occurrence, and/or direction of image capture, and/or source ID of each member events. The frequency of analysis depends on the purpose of the analysis; for example, it may be appropriate to carry out a new analysis of a cluster each time a new member is added or simply to do the analysis at fixed intervals.

The results of the analyses carried out by analysis functionality 17B are stored in database 16 to be available to the request handler 18 for responding to requests 19. In certain cases, an analysis may determine that an alert should be generated; in this case, the request handler 18 is directly informed to enable it to immediately send the alert to any user who has requested to receive the alert concerned.

The requests 19 will typically be location-based requests for information concerning attractions and places of interest near to the requester (user of apparatus 25). The location of the requesting apparatus 25 is, for example, derived in a manner similar to that described above in respect of the location of an image-capture event; furthermore, like the location of an image-capture event, the location of requesting apparatus maybe provided to the service system in the request itself or the latter may incorporate identification data for enabling the locatin to be retrieved from a location server. Where the request relates to an alert, since the alert may not be generated for some time, the request handler must either be provided with regular location updates concerning the requesting apparatus, or else the request handler must check the location of all apparatuses that have requested alerts whenever an alert is generated by the processing sub-system 17.

Having described the general form and functionality of the FIG. 1 embodiment, a more detailed description will now be given of certain aspects and, in particular of the processing carried out by the processing sub-system 17.

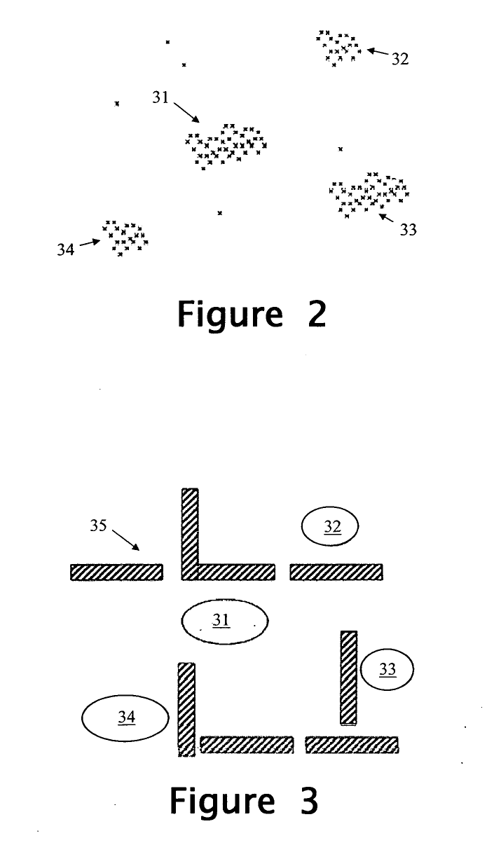

FIG. 2 illustrates an example disposition, by location, of image capture events notified to the service system 14, the individual events being indicated by crosses. The events are those that have occurred within the locality of a person who has requested information about attractions and places of interest near to the person. As can be seen, most of the events lie within one or other of four groups 31 to 34. The clustering functionality 17A is operative to determine that there are four clusters, also referenced 31 to 34 and shown in FIG. 3 by corresponding ovals. In FIG. 3 the clusters are shown overlaid on a map of the locality showing what buildings are present. In responding to the request for general information about attractions and places of interest in the locality, the request handler 18 will typically send back a combined cluster/map picture to the requestor (appropriate map data being retrieved from database 16 or any other suitable store).

FIGS. 3 to 6 illustrate how the provision of direction of image capture data for each event of a cluster can assist in the derivation of further useful information about the cluster. The direction of image capture is derived by an appropriate sensor (such as a magnetic or electronic compass) associated with the camera functionality, the direction reading produced by the sensor being captured at the same time as the image capture event takes place and being included as a direction of capture parameter in the image-capture event notification 13 sent to the service system.

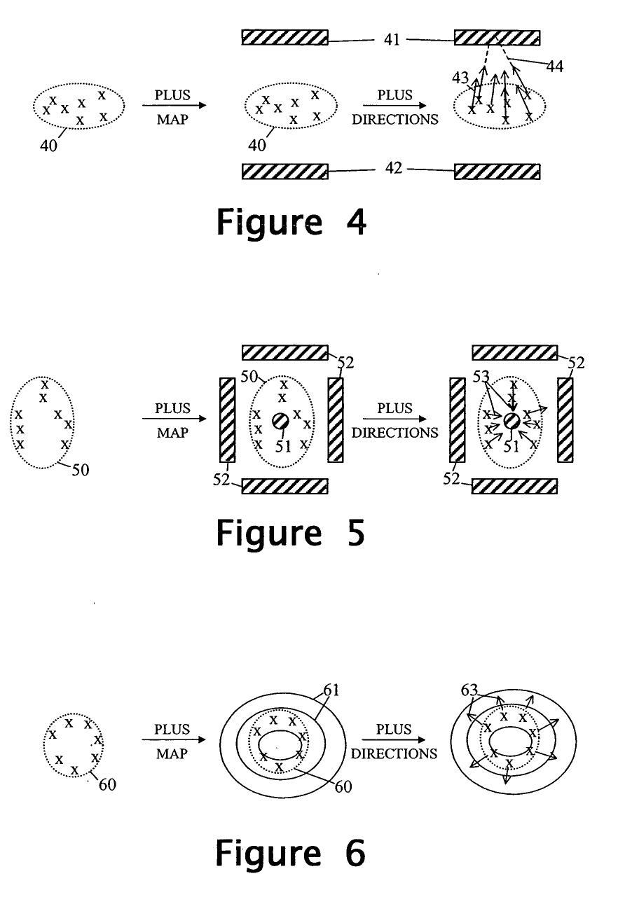

FIG. 3 depicts a group of seven events forming a cluster 40 as determined by the clustering functionality 17A. By itself, knowledge of the form and location of a cluster is of some use to a requestor of information about attractions and places of interest in the locality of the requestor. However, the addition of map features such as buildings 41 and 42 increases the usefulness of the information supplied to the requester. Nevertheless, this information does not indicate to the requestor which building is the one of interest—it could equally be building 41 or building 42. By using the direction of image capture information supplied with each event notification 13 the analysis functionality 17B is, however, able to determine that it is the building 41 that is the one of interest. In its simplest form the analysis carried out by functionality 17B is just to determine that more of the events are pointing towards building 41 than to 42—indeed, as illustrated by the arrows 43 coming from each event cross in the right-hand portion of FIG. 4, all of the events concern image capture towards the building 41. The analysis functionality 17B may further seek to pinpoint the likely subject of interest (such as an entranceway, a window etc. of building 41) by determining a point or area of intersection of the direction of capture lines (see dashed lines 44) with the building 41 or with whatever feature lies in the direction of the lines 44. The determined likely subject of the cluster of image capture events can then be reported to the requestor by highlighting on a map, by text or by any other suitable method.

In the FIG. 5 example, an image-capture event cluster 50 can be seen to lie in a courtyard formed by buildings 52 and in the center of which is a feature 51. It is not clear from the form and location of the cluster as superimposed on the building map, whether it is the buildings 52 that are of interest or the feature 51. However, when the direction of image capture for each event is taken into account (see arrows 53), it is clear that it is the feature 51 that is of interest. The analysis functionality 17B can again readily determine that the feature 51 is the likely subject of interest, enabling the request handler to report this to any requester.

Identification of the subject of interest enables the processing sub-system 17 to automatically seek a source of information, and in particular a website or part of a website, about the subject of interest. To do this, the processing sub-system 17 can either use the location of the subject to look up a relevant website in a location-to-website index directly, or use a map name for the subject to look up a relevant website in a directory or search for one using a search engine. If a relevant website is found, the URL of the website can be stored and provided by the request handler 18 to interested requesters.

In the FIG. 6 example, an image-capture event cluster 60 is found to lie in open country and in this case, the cluster is overlaid on a contour map rather than a building map (see contour lines 61 that here represent a hill). With this example it is not clear whether or not the majority of image capture events concern a feature on top of the hill. With the addition of direction of image capture information (see arrows 63), it becomes clear that it is not the top of the hill that is of interest but the view in any direction from the hill. The analysis functionality 17B is able to detect this from the supplied direction of image capture information and, given appropriate rules, can determine that the cluster 60 is located on a viewpoint. This characteristic of the cluster location is stored and reported to requesters of information about the locality. Other characteristics concerning the locality of a cluster can be similarly deduced from the patterns of image-capture directions encountered.

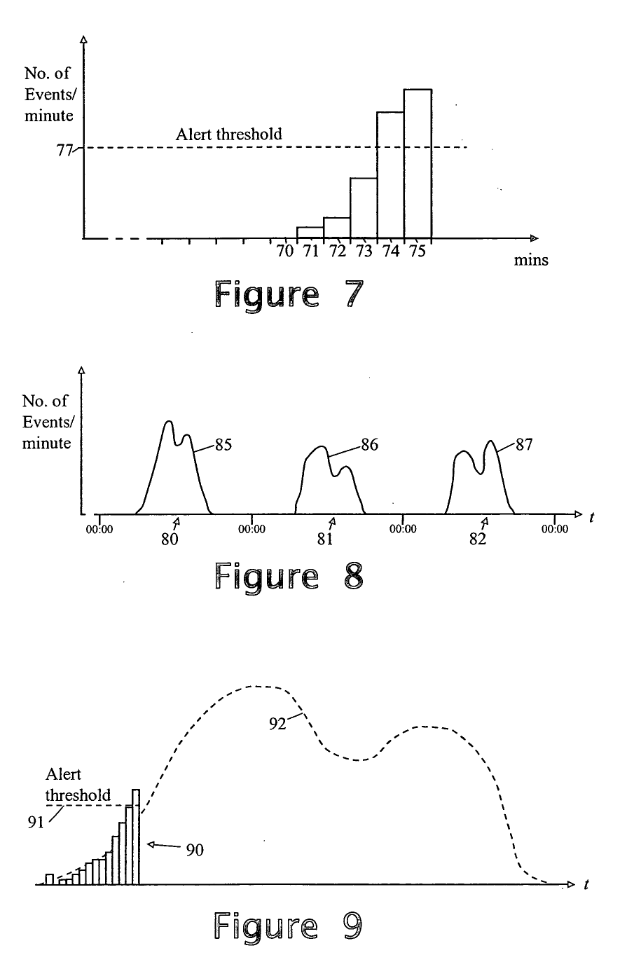

FIGS. 7 to 9 illustrate how knowing the time of occurrence of an image capture event can assist in the derivation of further useful information about a cluster of such events. A time indicative of when an image-capture event occurred can provided by one of:

a timestamp generated at the time of image capture by the camera functionality 10 effecting the image-capture event, the timestamp being included in the image-capture event notification 13;

a timestamp added by the communications functionality 11 and indicative of the time of transmission of the image-capture event notification 13;

the time of receipt by the service system of the image-capture event notification.

The latter two methods of providing time of occurrence information about an image-capture event are only useful where there is no major delay between the event itself and the sending/receipt of the corresponding event notification.

In the FIG. 7 example, the analysis functionality 17B is arranged to use the time of occurrence of new image capture events of a cluster to determine the current rate of addition of events to the cluster. More particularly, for each successive time period 70 to 75 (for example, each of one minute duration) a count is made of the number of cluster events newly occurring. When a predetermined threshold level 77 is reached (at time period 74 in FIG. 7), the functionality 17B generates an alert to indicate that something interesting is probably happening. This alert can be sent by the request handler to all apparatuses 25 within a certain range of the cluster 25 (on the basis that users of the apparatuses have, by the very fact of using the service system 14, implicitly requested to be alerted to such happenings); alternatively, the alert can be sent by the request handler 18 only to apparatuses that have explicitly requested to be notified of such alerts. Rather than the dissemination of alerts being limited to apparatuses within a predetermined range of the cluster concerned, a requestor can request to be notified of all alerts generated or all alerts generated within a specific geographic area.

The time period over which the rate of occurrence of new events is measured will depend upon various factors such as the nature of the subject of the image-capture events. If the intention is to be alerted to the occurrence of one-off attractions as they happen, then a short time period, typically ten minutes or less, is appropriate. However, for on-going attractions and places of interest, a requester may only want to know when the attraction has reached a particular level of popularity and in this case a time period of a day may be appropriate.

The rate of occurrence of new events in a cluster as a function of their time of occurrence effectively provides an image-capture event activity profile; such a profile is of interest independently of whether it is used to generate alerts. The analysis functionality 17B may therefore be arranged simply to determine and store this activity profile for supply by the request handler 18 to a requestor as needed.

FIG. 8 depicts the activity profile of an attraction that occurs daily. In FIG. 8, three 24 hr periods 80, 81 and 82 are illustrated. The 24 hr periodicity in the occurrence of events can be readily seen. However, the activity profile also contains additional information of interest. Thus, the activity profile for each day shows a double peak, one in the morning and one in the afternoon—the implication is that to avoid crowds it is better to arrive early or late, there only being a slight crowd reduction over the lunch period. Where the attraction that is the subject of the image-capture events has restricted access times, this will show up on the activity profile as strict start and stop times that do not correlate to daylight hours or the start and stop of public transport.

The analysis functionality 17B is preferably arranged to automatically detect periodicity in the occurrence of events of a cluster. This periodicity will typically be one (or more) of a daily periodicity, a weekly periodicity, a monthly periodicity, an annual periodicity. The periodicity of the attraction/place of interest associated with a cluster of image-capture events is preferably included to any report of the cluster to a requestor. The analysis functionality 17B can also arranged to detect any apparent artificial constraints on the time of occurrence of said image-capture events.

FIG. 9 illustrates the generation of an alert on the basis described above with respect to FIG. 7, namely that the rate of occurrence of new events in a cluster (as represented by the unit-time event count boxes 90) exceeds a predetermined threshold 91. In the FIG. 9 example, the cluster concerned has been determined to have periodicity and the analysis functionality 17B has calculated an averaged activity profile (dashed line 92). This profile is reported along with the alert to any interested requestor in order to provide the requester with an indication of the expected duration and popularity of the attraction associated with the event cluster.

Where the image-capture events of a cluster that exhibits periodicity only occur within a narrow time window (or windows) of each cycle of the cluster periodicity, then it is advantageous to arrange for the analysis functionality 17B to detect this situation and to generate an alert to indicate an upcoming or just commencing time window predicted for a current cycle of the cluster periodicity independently of any event notifications received for that window. Such alerts can be treated in the same way as other alerts, being sent to all apparatuses 25 automatically or only to specific requesters, and with or without the application of filtering based either on the current location of the apparatuses or on a requestor-specified geographic area of interest. Furthermore, the alert is preferably accompanied by the activity profile for the time window to provide the recipient with an indication of the expected duration and popularity of the attraction concerned.

The analysis functionality 17B can also be arranged to use the location and time of occurrence data about new events to make successive determinations of a centre of accretion of events to a cluster. Where the centre of accretion is determined to be changing in a non-random manner, the analysis functionality can be arranged to infer movement of the subject of the image-capture events. Information about this movement can be reported by the request handler 18 to interested requesters.

The service system is preferably arranged to discard data about events over a predetermined age at least for the purposes of the analyses conducted by the functionality 17B. Alternatively, events over a predetermined age can given reduced weight as compared to other events of the same cluster, at least in respect of analyses of the cluster.

In addition or alternatively to the analysis functionality 17B carrying out its analysis of a cluster on the basis of the time of occurrence and/or direction of image capture of image-capture events, the functionality can carry out analysis of a cluster on the basis of a source identifier associated with each event. Typically, this source identifier is either a user ID or an ID of the camera functionality 10 effecting the image-capture event concerned; in either case, the source identifier is generally included in the corresponding event notification. The analysis functionality 17B can be arranged to identify (and possibly count) events having the same source identifier in order to derive behaviour patterns or similar data. The identification of events having the same source identifier can also be used to identify the activity of persons, such as professional photographers, engaged to take photographs (for example, in a theme park).

Other event-specific parameters that can be used as a basis for cluster analysis include the angle of elevation of image capture and camera settings such as focus distance, focal length, shutter speed, flash settings, etc. An indication of the focus distance is particularly useful in determining the subject of an image-capture event and can be used fro this purpose either alone or in conjunction with another parameter such as the direction of image capture. Furthermore, it may be useful to disregard image-capture events with very short focal distances that occur in open spaces as such events are likely to have a family or group member as there subject rather than a building or other more regular attraction.

It will be appreciated that many variants are possible to the above described embodiments of the invention. For example, as well as passing parameter data about an image capture event to the service system, it is also possible to arrange for the captured images to be sent to the service system for sharing with others. In this case, each cluster preferably has an associated image library which a requestor can reach by clicking on a representation (typically on a map) of the corresponding event cluster. Rather than providing images for everyone to view, images can be provided in encrypted form or for storage on protected sites accessible to a closed user group only.

It is also possible to arrange for the request handler 18 to provide other information to a requester such as information added manually at the service system about the subject of each event cluster, and information about how to get from the requestor's current location to the location of a cluster of interest to the requestor.

1. An image-capture event monitoring method comprising the steps of:
(a) receiving, from multiple different sources, image-capture event notifications and deriving from each notification a location parameter indicative of where an image-capture event has occurred;
(b) using said location parameters to associate image-capture events into one or more clusters; and
(c) analysing a said cluster of image-capture events in dependence on at least one further parameter of each event.

2. A method according to claim 1, wherein in step (c) said at least one further parameter comprises a time indicative of when a said event occurred.

3. A method according to claim 2, wherein the time indicative of when a said event occurred is provided by one of:
a timestamp generated at the time of image capture by apparatus effecting the image-capture event, the timestamp being included in the image-capture event notification;
a timestamp indicative of the time of transmission of the image-capture event notification from the corresponding source;
the time of receipt in step (a) of the corresponding image-capture event notification.

4. A method according to claim 2, wherein step (c) comprises determining the current rate of occurrence of image-capture events for a cluster and generating an alert when a threshold value for this rate is reached.

5. A method according to claim 4, further comprising:
receiving, from a requestor, a request to be informed when the rate of occurrence of image-capture events increases to said threshold value, and
passing to the requestor any alert generated in respect of a said cluster that lies within said area.

6. A method according to claim 5, wherein said area is centred on a location provided by the requestor along with, or separately from, said request.

7. A method according to claim 4, wherein said rate of occurrence is measured in terms of the number events occurring in the cluster per day.

8. A method according to claim 4, wherein said rate of occurrence is measured in terms of the number events occurring in the cluster in a time period that no greater than ten minutes.

9. A method according to claim 2, wherein step (c) comprises producing, for a said cluster, an activity profile representing the rate of occurrence of events with respect to their time of occurrence.

10. A method according to claim 2, wherein step (c) comprises determining a periodicity in the time of occurrence of events of a said cluster.

11. A method according to claim 10, wherein said periodicity is one of:
a daily periodicity;
a weekly periodicity;
a monthly periodicity;
an annual periodicity

12. A method according to claim 10, wherein step (c) further comprises analysing a determined periodicity to detect any apparent artificial constraints on the time of occurrence of said image-capture events.

13. A method according to claim 10, wherein step (c) further comprises determining whether the events of a said cluster for which a periodicity has been determined are concentrated in narrow time windows of each cycle of the determined periodicity, and where this is the case, generating an alert to indicate an upcoming or just commencing said time window predicted for a current cycle of said periodicity.

14. A method according to claim 13, further comprising:
receiving, from a requestor, a request to receive any alerts generated in respect of any cluster within a certain area, and
passing to the requestor any alert generated in respect of a said cluster that lies within said area.

15. A method according to claim 14, wherein said area is centred on a location provided by the requestor along with, or separately from, said request.

16. A method according to claim 2, wherein step (c) comprises making successive determinations of a centre of accretion of events to a said cluster, and inferring movement of a subject of said image-capture events where the centre of accretion is determined to be changing in a non-random manner.

17. A method according to claim 2, wherein events over a predetermined age are discarded at least for the purposes of step (c).

18. A method according to claim 2, wherein for the purposes of step (c), events over a predetermined age are given reduced weight as compared to other events of the same cluster.

19. A method according to claim 1, wherein in step (c) said at least one further parameter comprises the direction of image capture associated with a said event, this direction being included in the corresponding notification.

20. A method according to claim 19, wherein in step (c) the directions of image capture of individual events of said cluster are used to determine the location of a potential subject of at least a group of events having convergent directions of image-capture.

21. A method according to claim 20, wherein step (c) includes correlating a said potential subject location with features of a map of the vicinity of the cluster thereby to identify a map feature as a candidate subject for the image-capture events.

22. A method according to claim 19, wherein in step (c) the direction of image capture of individual events of at least one group of events having convergent directions of image-capture, are used in conjunction with a map of the vicinity of the cluster under consideration to determine a candidate subject of said image-capture events.

23. A method according to claim 21, including the further step of determining the URL of a website about said candidate subject by lookup or search based on the location or a map-derived name of the candidate subject.

24. A method according to claim 22, including the further step of determining the URL of a website about said candidate subject by lookup or search based on the location or a map-derived name of the candidate subject.

25. A method according to claim 19, wherein in step (c) the direction of image-capture of individual events of said cluster are used in conjunction with a map of features in the vicinity of the cluster to determine a characteristic of the location of the cluster.

26. A method according to claim 1, wherein in step (c) said at least one further parameter comprises a source identifier.

27. A method according to claim 26, wherein said source identifier is a user ID included in the corresponding event notification.

28. A method according to claim 26, wherein said source identifier is an ID of image-capture apparatus effecting the image-capture event concerned, this ID being included in the corresponding event notification.

29. A method according to claim 26, wherein step (c) comprises identifying events having the same source identifier.

30. A method according to claim 1, wherein in step (c) said at least one further parameter comprises a camera setting value.

31. A method according to claim 30, wherein said camera setting is focus distance.

32. A method according to claim 1, in which results of the analysis carried out in step (c) are sent to a remote party in response to an information request.

33. An image-capture event monitoring method comprising the steps of:
capturing an image and causing at least the location of image capture to be made available substantially immediately to a service system;
at the service system, carrying out steps (a) to (c) according to claim 1.

34. A service system for monitoring image-capture events, the system comprising:
an input interface for receiving, from multiple different sources, image-capture event notifications and for deriving from each notification a location parameter indicative of where an image-capture event has occurred;
a data store for storing data derived from said event notifications;
a first processing arrangement for using said location parameters to associate image-capture events into one or more clusters; and
a second processing arrangement for analysing a said cluster of image-capture events in dependence on at least one further parameter of each event.

35. A system according to claim 34, wherein the said at least one further parameter in dependence upon which the second processing arrangement is arranged to carry out its analysis of said cluster, comprises a time indicative of when a said event occurred.

36. A system according to claim 35, wherein the time indicative of when a said event occurred is provided by a timestamp included in the corresponding image-capture event notification, the input interface being arranged to store this timestamp and the second processing means being arranged to receive the timestamp from the data store as required for carrying out its analysis of the corresponding event cluster.

37. A system according to claim 35, wherein the time indicative of when a said event occurred is the time of receipt of the corresponding image-capture event notification, the system including a time-indication arrangement for providing an indication of this time of receipt to the second processing arrangement.

38. A system according to claim 35, wherein the second processing arrangement is arranged to determine the current rate of occurrence of image-capture events for a cluster and to generating an alert when a threshold value for this rate is reached.

39. A system according to claim 38, further comprising a request handler for receiving, from a requestor, a request to be informed when the rate of occurrence of image-capture events of any cluster within a certain area reaches said threshold value, the request handler being arranged to pass to the requestor any alert generated in respect of a said cluster that lies within said area.

40. A system according to claim 38, wherein the second processing arrangement is arranged to determine said rate of occurrence in terms of the number events occurring in the cluster per day.

41. A system according to claim 37, wherein the second processing arrangement is arranged to determine said rate of occurrence in terms of the number events occurring in the cluster in a time period that no greater than ten minutes.

42. A system according to claim 35, wherein the second processing arrangement is arranged to produce, for a said cluster, an activity profile representing the rate of occurrence of events with respect to their time of occurrence.

43. A system according to claim 35, wherein the second processing arrangement is arranged to determine a periodicity in the time of occurrence of events of a said cluster.

44. A system according to claim 43, wherein said periodicity is one of:
a daily periodicity;
a weekly periodicity;
a monthly periodicity;
an annual periodicity

45. A system according to claim 43, wherein the second processing arrangement is further arranged to analyse a determined periodicity to detect any apparent artificial constraints on the time of occurrence of said image-capture events.

46. A system according to claim 43, wherein the second processing arrangement is further arranged to determine whether the events of a said cluster for which a periodicity has been determined are concentrated in narrow time windows of each cycle of the determined periodicity, and where this is the case, to generate an alert to indicate an upcoming or just commencing said time window predicted for a current cycle of said periodicity.

47. A system according to claim 46, further comprising a request handler for receiving, from a requestor, a request to receive any alerts generated in respect of any cluster within a certain area, the request handler being arranged to pass to the requestor any alert generated in respect of a said cluster that lies within said area.

48. A system according to claim 35, wherein the second processing arrangement is arranged to make successive determinations of a centre of accretion of events to a said cluster, and to infer movement of a subject of said image-capture events where the centre of accretion is determined to be changing in a non-random manner.

49. A system according to claim 35, wherein the system is arranged to discard events over a predetermined age at least for the purposes of the analysis which the second processing arrangement is arranged to effect.

50. A system according to claim 35, wherein the second processing arrangement is arranged to give events over a predetermined age a reduced weight as compared to other events of the same cluster.

51. A system according to claim 34, wherein the said at least one further parameter in dependence upon which the second processing arrangement is arranged to carry out its analysis of said cluster, comprises the direction of image capture associated with a said event, this direction being included in the corresponding notification.

52. A system according to claim 51, wherein the second processing arrangement is arranged to use the direction of image capture of individual events of said cluster to determine the location of a potential subject of at least a group of events having convergent directions of image-capture.

53. A system according to claim 52, wherein the second processing arrangement is arranged to correlate a said potential subject location with features of a map of the vicinity of the cluster thereby to identify a map feature as a candidate subject for the image-capture events.

54. A system according to claim 51, wherein the second processing arrangement is arranged to use the direction of image-capture of individual events of at least one group of events having convergent directions of image-capture, in conjunction with a map of the vicinity of the cluster under consideration, to determine a candidate subject of said image-capture events.

55. A system according to claim 53, further comprising a third processing arrangement for determining the URL of a website about said candidate subject by lookup or search based on the location or a map-derived name of the candidate subject

56. A system according to claim 54, further comprising a third processing arrangement for determining the URL of a website about said candidate subject by lookup or search based on the location or a map-derived name of the candidate subject

57. A system according to claim 51, wherein the second processing arrangement is arranged to use the direction of image-capture of individual events of said cluster, in conjunction with a map of features in the vicinity of the cluster, to determine a characteristic of the location of the cluster.

58. A system according to claim 34, wherein the said at least one further parameter in dependence upon which the second processing arrangement is arranged to carry out its analysis of said cluster, comprises a source identifier.

59. A system according to claim 58, wherein said source identifier is a user ID included in the corresponding event notification.

60. A system according to claim 58, wherein said source identifier is an ID of image-capture apparatus effecting the image-capture event concerned, this ID being included in the corresponding event notification.

61. A system according to claim 58, wherein the second processing arrangement is arranged to identify events having the same source identifier.

62. A system according to claim 35, wherein the said at least one further parameter comprises a camera setting value.

63. A system according to claim 62, wherein said camera setting is focus distance.

64. A system according to claim 34, further comprising a request handler for sending results of the analysis carried out by the second processing arrangement to a remote party in response to an information request.
